(19) United States
(12) Patent Application Publication
(10) Pub. No.: US 2002/0153323 A1
(43) Pub. Date: Oct. 24, 2002

(54) Process for the preparation of cation exchangers in gel form

(76) Inventors: Wolfgang Podszun, Koln (DE); Ulrich Schnegg, Leverkusen (DE); Reinhold Klipper, Koln (DE); Claudia Schmid, Leichlingen (DE)

Correspondence Address: BAYER CORPORATION, PATENT DEPARTMENT, 100 BAYER ROAD, PITTSBURGH, PA, 15205, US

(21) Appl. No.: 10/059,650

(22) Filed: Jan. 29, 2002

(30) Foreign Application Priority Data
Feb. 5, 2001 (DE) 10105103.4

(51) Int. Cl. C02F 1/42

(52) U.S. Cl. 210/681; 210/685

(57) ABSTRACT

Spherical copolymers prepared by a seed/feed process with a feed comprising vinylaromatic compounds, divinylbenzene, methyl acrylate, and free-radical initiator can be converted into cation exchangers in gel form having high stability and purity by sulfonation in the absence of a swelling agent.

### BACKGROUND OF THE INVENTION

The invention relates to a process for the preparation of cation exchangers in gel form having high stability and purity.

Cation exchangers can be obtained by functionalization of crosslinked styrene bead polymers.

One of the ways of preparing monodisperse bead polymers that are suitable as starting materials for ion exchangers is the so-called seed/feed process, in which a monodisperse polymer (“seed”) is swollen in the monomer and the latter is then polymerized. Thus, EP 98,130 B1 describes the preparation of styrene polymers in gel form by a seed/feed process in which the feed is added under polymerizing conditions to a seed that has been crosslinked with 0.1 to 3% by weight of divinylbenzene. EP 101,943 B1 discloses a seed/feed process in which a plurality of feeds of different composition are added successively to the seed under polymerizing conditions. U.S. Pat. No. 5,068,255 describes a seed/feed process in which a first monomer mixture is polymerized to a conversion of from 10 to 80% and a second monomer mixture that is essentially free from free-radical initiator is subsequently added as feed under polymerizing conditions.

EP-A 1,000,659 describes the preparation of acrylonitrile-containing copolymers by a seed/feed process and functionalization thereof using sulfuric acid to give cation exchangers. An advantage of EP-A 1,000,659 is that the acrylonitrile-containing copolymers can be functionalized without swelling agent. During the functionalization, however, the nitrile groups are saponified to carboxylic acid groups and in some cases also to amide groups. The presence of amide groups in the cation exchanger is disadvantageous in a number of respects. For example, the amide groups do not have an exchanger function and thus reduce the capacity of the exchanger. The amide groups may liberate traces of ammonia or ammonia compounds on use, which may be disadvantageous for some applications. In addition, handling of acrylonitrile requires considerable technical effort due to its toxic potential.

A further problem of the known cation exchangers is the fact that their mechanical and osmotic stability is not always adequate. Thus, cation exchanger beads may break up on dilution after sulfonation due to the osmotic forces that occur. For all applications of cation exchangers, the exchangers in bead form must retain their habit and must not be partially or even fully degraded during use or break down into fragments. Fragments and bead polymer splinters may enter the solutions to be purified during purification and themselves contaminate these solutions. Furthermore, the presence of damaged bead polymers is itself unfavorable for the functioning of the cation exchangers employed in column methods. Splinters result in an increased pressure loss in the column system and thus reduce the throughput of liquid to be purified through the column.

The object of the present invention is to provide a simple, robust process for the preparation of cation exchangers in gel form which have high stability and purity.

For the purposes of the present invention, the term “purity” is primarily taken to mean that the cation exchangers do not leach out. Leaching-out is evident from an increase in the conductivity of the water treated with the ion exchanger.

It has now been found that copolymers can be obtained by a seed/feed process using a monomer mixture comprising vinylaromatic compounds, divinylbenzene, methyl acrylate, and free-radical initiator as feed, and the copolymers obtained can be converted into cation exchangers in gel form having high stability and purity by sulfonation without swelling agents.

### SUMMARY OF THE INVENTION

The present invention relates to a process for the preparation of cation exchangers in gel form which have high stability and purity, comprising

(a) forming a suspension of seed polymer in a continuous aqueous phase,

(b) allowing the seed polymer to swell in an activated monomer mixture consisting essentially of

(i) 71 to 95.95% by weight of a vinylaromatic compound,

(ii) 3 to 20% by weight of divinylbenzene,

(iii) 1 to 8% by weight of methyl acrylate, and

(iv) from 0.05 to 1% by weight of free-radical initiator,

(c) polymerizing the activated monomer mixture in the seed polymer, and

(d) functionalizing the resulting copolymer by sulfonation in the absence of a swelling agent.

### DETAILED DESCRIPTION OF THE INVENTION

The seed polymer is a spherical polymer built up from vinyl monomers and crosslinking agents. Vinyl monomers are compounds having one free-radical-polymerizable C=C double bond per molecule. Preferred compounds of this type include aromatic monomers, such as, for example, vinyl and vinylidene derivatives of benzene and naphthalene (such as, for example, vinylnaphthalene, vinyltoluene, ethylstyrene, α-methylstyrene, chlorostyrenes, and styrene), and non-aromatic vinyl and vinylidene compounds, such as, for example, acrylic acid, methacrylic acid, C₁-C₈-alkyl acrylates, C₁C₈-alkyl methacrylates, acrylonitrile, methacrylonitrile, acrylamide, methacrylamide, vinyl chloride, vinylidene chloride, or vinyl acetate. The non-aromatic monomers are preferably present in the seed polymer in secondary amounts, preferably in amounts of from 0.1 to 50% by weight (particularly from 0.5 to 20% by weight), based on the aromatic monomers. In most cases, however, exclusively aromatic monomers are used.

The crosslinking of the seed polymer is based on a proportion of copolymerized compounds that contain two or more (preferably from two to four) free-radical-polymerizable double bonds per molecule. Examples that may be mentioned are the following: divinylbenzene, divinyltoluene, trivinylbenzene, divinylnaphthalene, trivinylnaphthalene, diethylene glycol divinyl ether, 1,7-octadiene, 1,5-hexadiene, ethylene glycol dimethyl acrylate, triethylene glycol dimethacrylate, trimethylolpropane trimethacrylate, allyl methacrylate, or methylene-N,N′-bisacrylamide. Divinylbenzene is preferred. The proportion of compounds copolymerized in the seed polymer, particularly divinylbenzene, is preferably from 0.5 to 6% by weight, particularly preferably from 0.8 to 5% by weight.

The particle size of the seed polymer is from 5 to 500 μm, preferably from 20 to 400 μm, particularly preferably from 100 to 300 μm. The shape of the particle-size distribution curve must correspond to that of the desired cation exchanger. In order to prepare an ion exchanger with a narrow or monodisperse distribution, use is accordingly made of a seed polymer with a narrow or monodisperse distribution. In a preferred embodiment of the present invention, a monodisperse seed polymer is employed. For the purposes of the present invention, the term “monodisperse” means that the quotient of the 90% value and the 10% value of the volume distribution function is less than 2, preferably less than 1.5, particularly preferably less than 1.25. In a further preferred embodiment of the present invention, the seed polymer is microencapsulated.

Suitable materials for the microencapsulation are all materials known for this purpose, particularly natural and synthetic polyamides, polyurethanes, and polyureas. A particularly suitable natural polyamide is gelatin. This is used, in particular, as a coacervate or complex coacervate. For the purposes of the present invention, the term “gelatin-containing complex coacervates” is taken to mean, in particular, combinations of gelatin and synthetic polyelectrolytes. Suitable synthetic polyelectrolytes are copolymers with copolymerized units of, for example, maleic acid, acrylic acid, methacrylic acid, acrylamide, and methacrylamide. Gelatin-containing capsules can be hardened using conventional hardeners, such as, for example, formaldehyde or glutaraldehyde. The preparation of spherical polymers that are suitable as seed polymer is described in detail in, for example, EP 46,535 B1. Microencapsulation with gelatin-containing complex coacervate is preferred.

The seed polymer is suspended in an aqueous phase, where the polymer:water ratio can be from 2:1 to 1:20, preferably from 1:2 to 1:10. The use of an auxiliary, for example, a surfactant or a protective colloid, is not necessary. The suspending can be carried out, for example, with the aid of a normal stirrer using low to moderate shear forces. In laboratory reactors with a capacity of 4 liters, speeds of from 80 to 300 rpm (revolutions per minute), for example, are used.

It is also possible to prepare the seed polymer by the suspension polymerization method and to use the resultant suspension for the process according to the invention without further work-up.

An activated monomer mixture comprising vinylaromatic compound, divinylbenzene and methyl acrylate is added to the suspended seed polymer, with the monomer mixture swelling into the seed polymer. For the purposes of the present invention, “activated” means that the monomer mixture contains a free-radical initiator. The addition of the monomer mixture can be carried out either at a low temperature, for example, at room temperature, or alternatively at an elevated temperature at which the free-radical initiator used is active. The rate of addition is unimportant at low temperature. At elevated temperature, the monomer mixture is metered in over a period of from 0.5 to 10 hours. It is possible to vary the rate of addition and/or the composition of the monomer mixture during the addition.

For the purposes of the present invention, the term “vinylaromatic compound” means a free-radical-polymerizable aromatic compound. Examples which may be mentioned are styrene, vinyinaphthalene, vinyl-toluene, ethylstyrene, α-methylstyrene, and chlorostyrenes. Styrene is preferred.

The proportion of the vinylaromatic compounds in the monomer mixture is from 71 to 91.95% by weight, preferably from 79.2 to 92.9% by weight.

The proportion of divinylbenzene in the monomer mixture is from 3 to 20% by weight, preferably from 5 to 14% by weight, based on the monomer mixture.

Methyl acrylate is employed in amounts of from 1 to 8% by weight, preferably from 2 to 6% by weight, based on the monomer mixture. Examples of free-radical initiators that are suitable for the process according to the invention are azo compounds, such as, for example, 2,2′-azobis (isobutyronitrile) or 2,2′-azobis(2-methylisobutyronitrile), or peroxy compounds, such as dibenzoyl peroxide, dilauryl peroxide, bis(p-chloro-benzoyl peroxide), dicyclohexyl peroxydicarbonate, tert-butyl peroctanoate, 2,5-bis(2-ethylhexanoylperoxy)-2,5-dimethylhexane, or tert-amylperoxy-2-ethylhexane. It is of course possible and in many cases advantageous to employ mixtures of different free-radical initiators, for example, of free-radical initiators having different decomposition temperatures. The free-radical initiators are generally used in amounts of from 0.05 to 1% by weight, preferably from 0.1 to 0.8% by weight, based on the monomer mixture.

The ratio between the seed polymer and the added monomer mixture (seed/feed ratio) is generally from 1:0.5 to 1:12, preferably from 1:1 to 1:8, particularly preferably from 1:1.5 to 1:6. The added mixture swells into the seed polymer. The maximum amount of the monomer mixture referred to as “feed” which is taken up completely by the seed depends to a considerable extent on the crosslinking agent content of the seed. For a given particle size of the seed polymer, the particle size of the resultant copolymer or ion exchanger can be adjusted via the seed/feed ratio.

The polymerization of the swollen seed polymer to give the copolymer is carried out in the presence of one or more protective colloids and, if desired, in the presence of a buffer system. For the purposes of the present invention, “protective colloids” are natural or synthetic water-soluble polymers, such as, for example, gelatin, starch, polyvinyl alcohol, polyvinylpyrrolidone, polyacrylic acid, polymethacrylic acid, or copolymers of (meth)acrylic acid or (meth)acrylates. Cellulose derivatives, particularly cellulose esters or cellulose ethers, such as carboxymethylcellulose or hydroxyethylcellulose, are very highly suitable. Cellulose derivatives are preferred as protective colloid. The amount of protective colloids used is generally from 0.05 to 1% by weight, preferably from 0.1 to 0.5% by weight, based on the water phase.

In a preferred embodiment of the present invention, the polymerization is carried out in the presence of a buffer system. Preference is given to buffer systems which set the pH of the water phase at the beginning of the polymerization to a value of from 14 to 6, preferably from 13 to 9. Under these conditions, protective colloids containing carboxyl groups are fully or partially in the form of salts. In this way, the action of the protective colloids is favorably influenced. Particularly preferred buffer systems for the purposes of the present invention contain phosphate or borate salts.

If desired, an inhibitor can be added to the aqueous phase. Suitable inhibitors for the purposes of the present invention are both inorganic and organic substances. Examples of inorganic inhibitors are nitrogen compounds, such as hydroxylamine, hydrazine, sodium nitrite, or potassium nitrite. Examples of organic inhibitors are phenolic compounds, such as hydroquinone, hydroquinone monomethyl ether, resorcinol, pyro-catechol, and tert-butylpyrocatechol, and products of the condensation of phenols with aldehydes. Further organic inhibitors are nitrogen-containing compounds, such as, for example, diethylhydroxylamine or isopropyl-hydroxylamine. The concentration of the inhibitor is 5 to 1000 ppm, preferably 10 to 500 ppm, particularly preferably 20 to 250 ppm, based on the aqueous phase.

The ratio between the organic phase and the water phase during the polymerization of the swollen seed is from 1:0.6 to 1:10, preferably from 1:1 to 1:6.

The temperature during the polymerization of the swollen seed polymer depends on the decomposition temperature of the initiator employed. It is generally from 50 to 150° C., preferably from 60 to 130° C. The polymerization takes from 1 to a few hours. It has proven successful to use a temperature program in which the polymerization is begun at low temperature, for example 60° C., and the reaction temperature is increased with progressing polymerization conversion. In this way, the requirement for safe progress of the reaction and high polymerization conversion, for example, can be satisfied very well. The process according to the invention is preferably carried out in a process-controlled plant.

After the polymerization, the copolymer can be isolated by conventional methods, for example, by filtration or decantation, and, if necessary, dried after one or more washes, and, if desired, sieved.

The conversion of the copolymers into the cation exchanger is carried out by sulfonation. Suitable sulfonating agents are sulfuric acid, sulfur trioxide, and chlorosulfonic acid. Preference is given to sulfuric acid in a concentration of from 90 to 100%, particularly preferably from 92 to 98%. The temperature during the sulfonation is generally from 50 to 200° C., preferably from 90 to 150° C. It has been found that the copolymers according to the invention can be sulfonated without addition of swelling agents (such as, for example, chlorobenzene, dichloropropane, or dichloroethane) to give homogeneous sulfonation products.

The reaction mixture is stirred during the sulfonation. Various types of stirrer, such as blade, anchor, gate-type, or turbine stirrers, can be employed.

In a particular embodiment of the present invention, the sulfonation is carried out by the so-called “semi-batch process”. In this method, the copolymer is metered into the sulfuric acid, which is at a controlled temperature. It is particularly advantageous to carry out the metering in portions.

After the sulfonation, the reaction mixture comprising sulfonation product and residual acid is cooled to room temperature and diluted first with sulfuric acids of decreasing concentrations and then with water.

If desired, the cation exchanger in the H form obtainable in accordance with the invention can, for purification, be treated with deionized water at temperatures of 70 to 145° C., preferably 105 to 130° C.

The present invention therefore also relates to monodisperse cation exchangers in gel form obtainable by

(a) formation of a suspension of seed polymers in a continuous aqueous phase,

(b) swelling of the seed polymer in an activated monomer mixture consisting essentially of

(i) 71 to 95.95% by weight of a vinylaromatic compound,

(ii) 3 to 20% by weight of divinylbenzene,

(iii) 1 to 6% by weight of methyl acrylate, and

(iv) from 0.05 to 1% by weight of free-radical initiator,

(c) polymerization of the monomer mixture in the seed polymer, and

(d) functionalization of the resultant copolymer by sulfonation in the absence of a swelling agent.

It is favorable for many applications to convert the cation exchangers prepared in accordance with the invention from the acidic form into the sodium form. This charge exchange is carried out, for example, using sodium hydroxide solution having a concentration of 10 to 60%, preferably 40 to 50%.

After the charge exchange, the cation exchangers can, for further purification, be treated with deionized water or aqueous salt solutions, preferably with sodium chloride or sodium sulfate solutions. It has been found here that treatment at 70 to 150° C. (preferably 120 to 135° C.) is particularly effective and does not cause a reduction in the capacity of the cation exchanger.

The cation exchangers obtainable by the process according to the invention are distinguished by particularly high stability and purity. They do not exhibit any defects in the ion exchanger beads or leaching of the exchanger even after extended use and multiple regeneration.

Due to their high purity and the consequent low leaching behavior, the cation exchangers according to the invention have a multiplicity of different applications. Thus, they can be employed, for example, in the treatment of drinking water, in the preparation of ultrahigh purity water (necessary in the production of microchips for the computer industry), for the chromatographic separation of sugars, particularly glucose and fructose, or as catalysts for various chemical reactions (such as, for example, in the preparation of bisphenol A from phenol and acetone). It is desired for most of these applications that the cation exchangers do the intended functions without releasing impurities, which may emanate from their preparation or be formed by polymer degradation during use, to their environment. The presence of impurities in water flowing off from the cation exchanger is evident from the fact that the conductivity and/or organic carbon content (TOC content) in the water is/are increased.

The present invention therefore also relates to a process for the production of microchips, for the synthesis of bisphenol A, for the preparation of ultrahigh purity water, or for the separation of sugars, particularly of glucose and fructose, in which the cation exchangers according to the invention are employed during these processes.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Analytical Methods

Determination of the Stability of Cation Exchangers by Alkali Plunge

2 ml of sulfonated copolymer in the H form are introduced with stirring at room temperature into 50 ml of 45% strength by weight sodium hydroxide solution. The suspension is left to stand overnight. A representative amount of sample is subsequently withdrawn. 100 beads are observed under the microscope. The number of perfect, undamaged beads of these is determined.

Determination of the Conductivity in the Eluate From Cation Exchangers

100 ml of suction-filter-moist cation exchanger in the H form are introduced into a glass column having a length of 60 cm and a diameter of 2 cm that is held at a temperature of 70° C. 480 ml of deionized water are passed through the column from top to bottom at a flow rate of 20 ml/h (0.2 bed volume per hour). The conductivity of the liquid emerging from the bottom of the column is determined after flow of 200 ml (corresponding to two bed volumes) and after flow of 400 ml (corresponding to 4 bed volumes) and measured in μS per cm.

### Example 1

(According to the Invention)

(1a) Preparation of a Seed Polymer

1960 ml of deionized water were introduced into a 4 liter glass reactor. 630 g of a microencapsulated mixture of 1.0% by weight of divinylbenzene, 0.6% by weight of ethylstyrene (employed as a commercially available mixture of divinylbenzene and ethylstyrene comprising 63% of divinylbenzene), 0.5% by weight of tert-butyl peroxy-2-ethylhexanoate, and 97.9% by weight of styrene were introduced into the reactor, where the microcapsules consisted of a formaldehyde-hardened complex coacervate comprising gelatin and an acrylamidelacrylic acid copolymer. The mean particle size was 231 μm. A solution of 2.4 g of gelatin, 4 g of sodium hydrogenphosphate dodecahydrate, and 100 mg of resorcinol in 80ml of deionized water was added to the mixture, and the mixture was stirred slowly and polymerized for 10 hours at 75° C. with stirring. The polymerization was subsequently completed by increasing the temperature to 95° C. The batch was washed via a 32 μm sieve and dried, giving 605 g of a spherical, microencapsulated bead polymer having a smooth surface. The bead polymers appeared optically transparent; the mean particle size was 220 μm.

(1b) Preparation of a Copolymer

279.1 g of seed polymer from (1a) and an aqueous solution of 1100 g of deionized water, 3.6 g of boric acid, and 1 g of sodium hydroxide were introduced into a 4 liter glass reactor, and the stirring speed was set to 220 rpm (revolutions per minute). Over the course of 30 minutes, a mixture of 775.3 g of styrene, 60.0 g of methyl acrylate, 85.9 g of divinylbenzene (80.6% strength by weight), 3.3 g of tert-butyl peroxy-2-ethylhexanoate, and 2.3 g of tert-butyl peroxybenzoate was added. The mixture was stirred at room temperature for 60 minutes, during which the gas space was flushed with nitrogen. A solution of 2.4 g of methylhydroxyethylcellulose in 120 g of deionized water was then added. The batch was then heated to 63° C. and left at this temperature for 11 hours, and the batch was subsequently transferred into an autoclave and warmed at 130° C. for 3 hours. After cooling, the batch was washed thoroughly with deionized water via a 40 μm sieve and then dried for 18 hours at 80° C. in a drying cabinet, giving 1156 g of a spherical copolymer having a particle size of 420 μm.

(1c) Preparation of a Cation Exchanger

1800 ml of 97.32% strength by weight sulfuric acid were introduced into a 2 liter four-necked flask and heated to 100° C. A total of 400 g of dry copolymer from (1b) were introduced in 10 portions over the course of 4 hours with stirring. The mixture was subsequently stirred at 100° C. for a further 4 hours. After cooling, the suspension was transferred into a glass column. Sulfuric acids of decreasing concentration, starting with 90% strength by weight, and finally pure water were filtered through the column from the top, giving 1980 ml of cation exchanger in the H form.

| | |
|---|---|
| Stability test/alkali plunge. | 99/100 |
| Number of perfect beads | |
| Conductivity in the eluate after 2 and 4 bed volumes | 94/62 |
| μS/cm | |

(1d) Charge Exchange of the Cation Exchanger

For charge exchange of the cation exchanger from the H form into the sodium form, 1700 ml of sulfonated product from (1c) and 850 ml of ultrahigh purity water were introduced into a 4 liter glass reactor at room temperature. The suspension was heated to 80° C., and 480 g of 45% strength by weight aqueous sodium hydroxide solution were added over the course of 30 minutes. The mixture was stirred at 80° C. for a further 15 minutes. After cooling, the product was washed with deionized water, giving 1577 ml of cation exchanger in the Na form.

Example 2

(According to the Invention)

(2b) Preparation of a Copolymer

279.1 g of seed polymer from (1a) and an aqueous solution of 1100 g of deionized water, 3.6 g of boric acid, and 1 g of sodium hydroxide were introduced into a 4 liter glass reactor, and the stirring speed was set to 220 rpm. Over the course of 30 minutes, a mixture of 745.5 g of styrene, 60.0 g of methyl acrylate, 115.7 g of divinylbenzene (80.6% strength by weight), 3.3 g of tert-butyl peroxy-2-ethylhexanoate, and 2.3 g of tert-butyl peroxy-benzoate was added. The mixture was stirred at room temperature for 60 minutes, during which the gas space was flushed with nitrogen. A solution of 2.4 g of methylhydroxyethylcellulose in 120 g of deionized water was then added. The batch was then heated to 63° C. and left at this temperature for 11 hours, and the batch was subsequently transferred into an autoclave and warmed at 130° C. for 3 hours. After cooling, the batch was washed thoroughly with deionized water via a 40 μm sieve and then dried for 18 hours at 80° C. in a drying cabinet, giving 1186 g of a spherical copolymer having a particle size of 420 μm.

(2c) Preparation of a Cation Exchanger

1800 ml of 97.5% strength by weight sulfuric acid were introduced into a 2 liter four-necked flask and heated to 100° C. A total of 400 g of dry copolymer from (2b) were introduced in 10 portions over the course of 4 hours with stirring. The mixture was subsequently stirred at 100° C. for a further 4 hours. After cooling, the suspension was transferred into a glass column. Sulfuric acids of decreasing concentration, starting with 90% strength by weight, and finally pure water were filtered through the column from the top, giving 1715 ml of cation exchanger in the H form.

| | |
|---|---|
| Stability test/alkali plunge. | 98/100 |
| Number of perfect beads | |
| Conductivity in the eluate after 2 and 4 bed volumes | 92/64 |
| μS/cm | |

### Example 3

(According to the Invention)

(3b) Preparation of a Copolymer

279.1 g of seed polymer from (1a) and an aqueous solution of 1100 g of deionized water, 3.6 g of boric acid, and 1 g of sodium hydroxide were introduced into a 4 liter glass reactor, and the stirring speed was set to 220 rpm. Over the course of 30 minutes, a mixture of 772.4 g of styrene, 48.0 g of methyl acrylate, 100.8 g of divinylbenzene (80.6% strength by weight), 3.3 g of tert-butyl peroxy-2-ethylhexanoate, and 2.3 g of tert-butyl peroxybenzoate was added. The mixture was stirred at room temperature for 60 minutes, during which the gas space was flushed with nitrogen. A solution of 2.4 g of methylhydroxyethylcellulose in 120 g of deionized water was then added. The batch was then heated to 63° C. and left at this temperature for 11 hours, and the batch was subsequently transferred into an autoclave and warmed at 130° C. for 3 hours. After cooling, the batch was washed thoroughly with deionized water via a 40 μm sieve and then dried for 18 hours at 80° C. in a drying cabinet, giving 1186 g of a spherical copolymer having a particle size of 420 μm.

(3c) Preparation of a Cation Exchanger

1800 ml of 97.5% strength by weight sulfuric acid were introduced into a 2 liter four-necked flask and heated to 100° C. A total of 400 g of dry copolymer from (3b) were introduced in 10 portions over the course of 4 hours with stirring. The mixture was subsequently stirred at 100° C. for a further 4 hours. After cooling, the suspension was transferred into a glass column. Sulfuric acids of decreasing concentration, starting with 90% strength by weight, and finally pure water were filtered through the column from the top, giving 1815 ml of cation exchanger in the H form.

| | |
|---|---|
| Stability test/alkali plunge. | 98/100 |
| Number of perfect beads | |
| Conductivity in the eluate after 2 and 4 bed volumes | 95/54 |
| μS/cm | |

Example 4

(According to the Invention)

a) Preparation of a Seed Polymer

1989.6 g of demineralized water, 1.9 g of methylhydroxyethyl-cellulose, and 8.5 g of sodium hydrogenphosphate dodecahydrate were introduced into a 4 liter glass reactor. A mixture of 712.8 g of styrene, 37.2 g of divinylbenzene (80.6% strength by weight), and 5.55 g of dibenzoyl peroxide (75% strength by weight) were metered into the stirred mixture (300 revolutions per minute) at room temperature over the course of 30 minutes. The mixture was polymerized at 66° C. for 6 hours, with the gas space being flushed with nitrogen during 15 minutes of the heating time, and the mixture was subsequently polymerized to completion at 95° C. and then cooled.

b) Preparation of a Copolymer

A monomer mixture consisting of 511.4 g of styrene, 163.6 g of divinylbenzene (55% strength by weight), 75.0 g of methyl acrylate, and 6.0 g of dibenzoyl peroxide (75% strength by weight) were metered into the seed mixture a), which was stirred at 220 rpm, at room temperature over the course of 30 minutes.

The mixture was then heated to 50° C., with the gas space being flushed with nitrogen during 15 minutes of the heating time, and subsequently stirred at 50° C. for 2 hours. A dispersant solution consisting of 497.4 g of deionized water, 0.48 g of methylhydroxyethylcellulose, 2.13 g of sodium hydrogenphosphate dodecahydrate, and 0.25 g of resorcinol was added. After a further hour at 50° C., the mixture was polymerized at 66° C. for 6 hours and polymerized to completion at 95° C. for 4 hours. After cooling, the batch was washed thoroughly with deionized water via a 315 μm sieve and dried overnight in a drying cabinet. The yield in the target size range of 315 to 630 μm was 1189.1 g of spherical copolymer.

c) Preparation of a Cation Exchanger

91.6 g of a sulfuric acid having a content of 78% by weight of H₂SO₄ were introduced into a 500 ml flask with plane ground glass joints. 50 g of dry copolymer from 4b were added at 80° C. with stirring. 274.8 g of sulfuric acid (100% strength by weight) were subsequently added. The mixture was heated to 110° C. over the course of 1 hour and maintained at this temperature for 3 hours. The mixture was then heated to 140° C. over the course of 1 hour and stirred at 140° C. for 4 hours. The mixture was subsequently cooled to 30° C., and the acid was separated off via a column with glass frit. Two bed volumes each of fresh acids of decreasing concentration and subsequently deionized water were filtered through the column. 220 ml of cation exchanger in the H form were obtained as round, black beads.

| | |
|---|---|
| Stability test/alkali plunge. | 98/98 |
| Number of perfect beads | |
| Conductivity in the eluate after 2 and 4 bed volumes | 88/66 |
| μS/cm | |

d) Charge Exchange of a Cation Exchanger

162 ml of the cation exchanger in the H form were transferred into a column with glass frit. 600 g of a sodium hydroxide solution (4% strength by weight) were rapidly added dropwise. Deionized water was subsequently allowed to drop through slowly at first, then at a faster rate. Back-flushing from below with deionized water was subsequently carried out so that the fines content was classified. The yield of cation exchanger in the Na form was 150 ml.

What is claimed is:

1. A process for the preparation of monodisperse cation exchangers in gel form which have high stability and purity comprising
(a) forming a suspension of seed polymer in a continuous aqueous phase,
(b) allowing the seed polymer to swell in an activated monomer mixture consisting essentially of
(i) 71 to 95.95% by weight of a vinylaromatic compound,
(ii) 3 to 20% by weight of divinylbenzene,
(iii) 1 to 6% by weight of methyl acrylate, and
(iv) from 0.05 to 1% by weight of free-radical initiator,
(c) polymerizing the monomer mixture in the seed polymer, and
(d) functionalizing the resulting copolymer by sulfonation in the absence of a swelling agent.

2. A process according to claim 1 wherein the seed polymer has a particle size distribution in which the quotient of the 90% value and the 10% value of the volume distribution function is less than 2.

3. A process according to claim 1 wherein the seed polymer is a crosslinked polymer having a DVB content of from 0.5 to 6%.

4. A process according to claim 1 wherein the seed polymer is microencapsulated.

5. A process according to claim 1 wherein the ratio between the seed polymer and the monomer mixture is from 1:0.5 to 1:12.

6. A monodisperse cation exchanger in gel form obtained by
(a) formation of a suspension of seed polymer in a continuous aqueous phase,
(b) swelling of the seed polymer in an activated monomer mixture consisting essentially of
(i) 71 to 95.95% by weight of a vinylaromatic compound,
(ii) 3 to 20% by weight of divinylbenzene,
(iii) 1 to 6% by weight of methyl acrylate, and
(iv) from 0.05 to 1% by weight of free-radical initiator,
(c) polymerization of the monomer mixture in the seed polymer, and
(d) functionalization of the resultant copolymer by sulfonation in the absence of a swelling agent.

7. A cation exchanger obtained by converting a monodisperse cation exchanger from the acidic form into the sodium form by charge exchange.

8. A process for the purification of a cation exchanger in the sodium form according to claim 7 comprising treating the cationic exchanger with deionized water or an aqueous salt solution.

9. A method comprising treating drinking water with a monodisperse cation exchanger according to claim 6.

10. A method comprising preparing ultrahigh-purity water with a monodisperse cation exchanger according to claim 6.

11. A method comprising chromatographically separating sugars with a monodisperse cation exchanger according to claim 6.

12. A method comprising catalyzing chemical reactions with a monodisperse cation exchanger according to claim 6.
